(19) United States
(12) Patent Application Publication
(10) Pub. No.: US 2015/0021099 A1
(43) Pub. Date: Jan. 22, 2015

(54) CUTTING MEMBERS WITH INTEGRATED ABRASIVE ELEMENTS

(71) Applicant: Neil Shaw, Yamhill, OR (US)

(72) Inventor: Neil Shaw, Yamhill, OR (US)

(21) Appl. No.: 13/945,497

(22) Filed: Jul. 18, 2013

(51) Int. Cl. B24D 7/06; E21B 10/02; B23D 61/02

(52) U.S. Cl. CPC B24D 7/06; B23D 61/028; E21B 10/02
USPC 175/403; 451/540; 83/676

(57) ABSTRACT

Cutting members including a body including a first surface, a second surface spaced from the first surface and extending in a plane substantially aligned with the first surface, a leading surface extending between the first surface and the second surface, the leading surface extending in a plane transverse to the first surface and the second surface, and an attaching surface distal the leading surface, the attaching surface extending between the first surface and the second surface and a plurality of abrasive elements integrated in the body. In some examples, the cutting member is configured as a cylindrical drill bit and the abrasive elements are aligned transverse the leading surface. In some further examples, the cutting member is configured as a circular disk and the abrasive elements are aligned transverse the first surface and the second surface.

### CROSS REFERENCE TO RELATED APPLICATIONS

This application claims priority to copending U.S. Application, Ser. No. 61/742,476, filed on Aug. 13, 2012, which is hereby incorporated by reference for all purposes.

### BACKGROUND

The present disclosure relates generally to cutting members. In particular, cutting members with integrated abrasive elements are described.

Known cutting members are not entirely satisfactory for the range of applications in which they are employed. For example, existing cutting members rely on diamond abrasive compounds or coatings precariously adhered to the crown or leading edges of the cutting members. Conventional edge-adhered abrasive compounds are brittle and likely to break, crack, or flake off of the cutting members during use. Thus, the edge-adhered abrasive compounds are readily subject to degradation and damage, and have a short useful lifespan even under ideal working conditions.

Further, conventional cutting members utilize metal cutting member bodies with abrasive diamond grit coatings. Conventional cutting members often employ abrasive coatings that are brazed or welded onto the edge of the cutting member body. Conventional abrasive element configurations include crowns in the form of continuous rings, or segments in the form of isolated abrasive elements. Existing abrasive-coated crowns and segments are likely to be damaged or destroyed by shock waves generated by drilling, coring, cutting, or grinding solid material; conventional cutting members are shock sensitive.

Additionally, conventional edge-mounted abrasive coatings are relatively thin, usually under 1 cm, and offer a limited abrasive surface area. The limited abrasive surface of conventional cutting members quickly thins and dulls, thereby increasing time required to drill, core, cut, or grind solid material. Indeed, thinning of conventional abrasive coatings does not allow existing cutting members to maintain gauge during core drilling.

Maintaining gauge is essential when core drilling, however, existing cutting members cause unacceptable delays and additional expenses by failing to maintain gauge. When conventional abrasive compounds thin, the cutting surface of the core bit narrows and the core path becomes narrow on the leading edge. Narrowing of the cutting surface narrows the gauge of the core path, which is catastrophic in the core drilling industry. After drilling for miles it is not uncommon for conventional cutting members to fail to maintain gauge, thereby requiring abandoning of the current core path and beginning a new path from scratch. Abandoning a core path to begin anew is prohibitively time consuming and expensive.

In addition, existing cutting members are fragile and often fail due to percussion effects prevalent when performing interrupted cutting or coring of sharp-edged, hard rock fracture zones. Indeed, the brittle and precariously mounted abrasive elements of existing cutting members are likely to be damaged or destroyed when deployed in the high rotational velocity environment of core drilling or cutting. Existing cutting members often crack or fracture when existing abrasive elements fail. Thus, existing cutting members are not ideal for every-day working conditions common in the field.

Additionally, conventional cutting members are subject to being damaged or destroyed from mere rough handling or misuse. The precariously mounted and brittle abrasive elements of conventional cutting members are often inadvertently damaged or destroyed by dropping the cutting member on hard surfaces or impacting the cutting member with other heavy tools used in the field. Thus, even when not using conventional cutting members for coring or cutting, conventional cutting members are subject being damaged or destroyed by common rough handling.

Thus, there exists a need for cutting members that improve upon and advance the design of known cutting members. Examples of new and useful cutting members relevant to the needs existing in the field are discussed below.

### SUMMARY

The present disclosure is directed to cutting members including a body including a first surface, a second surface spaced from the first surface and extending in a plane substantially aligned with the first surface, a leading surface extending between the first surface and the second surface, the leading surface extending in a plane transverse to the first surface and the second surface, and an attaching surface distal the leading surface, the attaching surface extending between the first surface and the second surface and a plurality of abrasive elements integrated in the body. In some examples, the cutting member is configured as a cylindrical drill bit and the abrasive elements are aligned transverse the leading surface. In some further examples, the cutting member is configured as a circular disk and the abrasive elements are aligned transverse the first surface and the second surface.

### BRIEF DESCRIPTION OF THE DRAWINGS

FIG. 1 is a front perspective view of a first example of a cutting member.

FIG. 2 is a side elevation view of the cutting member shown in FIG. 1, depicting the cutting member configured to mount to a threaded bore.

FIG. 3 is a top elevation view of the cutting member shown in FIG. 1, depicting an interface between a leading surface and abrasive elements.

FIG. 4 is a front perspective view of a second example of a cutting member, which includes abrasive elements integrated in a body transverse a leading surface.

FIG. 5 is a side elevation view of the cutting member shown in FIG. 4, depicting a cylindrical configuration of the abrasive elements.

FIG. 6 is a top elevation view of the cutting member shown in FIG. 4, depicting an interface between a first surface and the abrasive elements and a second surface and the abrasive elements.

FIG. 7 is a front perspective view of a third example of a cutting member configured as a circular disk.

FIG. 8 is a top elevation view of the cutting member shown in FIG. 7, depicting abrasive elements arranged in a primary outer ring and a secondary inner ring.

FIG. 9 is a side elevation view of the cutting member shown in FIG. 7, depicting an interface between a leading surface and the abrasive elements.

FIG. 10 is a cross-section view of the cutting member shown in FIG. 7, depicting an aperture in an attaching surface.

FIG. 11 is a front perspective view of a fourth example of a cutting member configured as a circular disk.

FIG. 12 is a top elevation view of the cutting member shown in FIG. 11, depicting abrasive elements integrated transverse a leading surface.

FIG. 13 is a side elevation view of the cutting member shown in FIG. 11, depicting a staggered arrangement of the abrasive elements relative to the leading surface, a first surface, and a second surface.

FIG. 14 is a cross-section view of the cutting member shown in FIG. 11, depicting an aperture in an attaching surface.

### DETAILED DESCRIPTION

The disclosed cutting members will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various cutting members are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

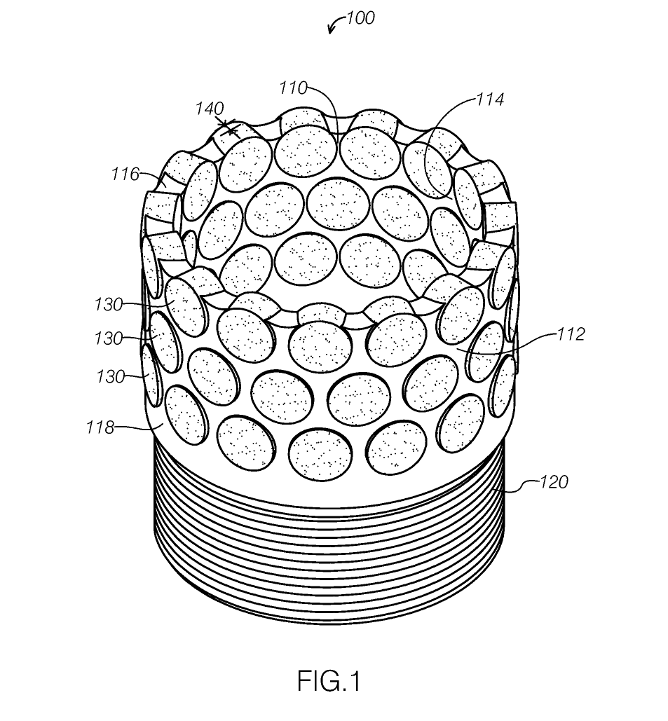

With reference to FIGS. 1-3, a first example of a cutting member, cutting member 100, will now be described. Cutting member 100 includes a cylindrical body 110, a first surface 112, a second surface 114, a leading surface 116, an attaching surface 118, an attaching member 120, and a plurality of abrasive elements 130.

Cutting member 100 facilitates or allows drilling, coring, cutting or grinding of solid materials. Specifically, cutting member 100 is configured for core sampling of solid materials, including, but not limited to, natural rock, concrete and metal. Additionally or alternatively, cutting member 100 can be used in conjunction with demolition tools and explosives for solid material demolition. Additionally or alternatively, cutting member 100 can be used to cut or bore solid surfaces to allow electrical or plumbing installation.

A natural example addressing the limitations of existing cutting members discussed above is embodied in the teeth of elephants. Elephant teeth demonstrate a continually regenerating grinding surface configured to grind and mash solid surfaces; when the grinding surface wears thin or becomes dull, the surface is replaced by a fresh, new grinding surface. As elephant teeth continually regenerate grinding surfaces, cutting member 100 continually regenerates grinding surfaces, as embodied in abrasive elements 130.

As cutting member 100 is utilized to drill, core, cut or grind solid materials, abrasive elements 130 are exposed as body 110 erodes. Abrasive elements 130 are equivalent to freshly replenished elephant teeth with new grinding surfaces; abrasive elements 130 provide a continually regenerating, self-sharpening drilling, coring, cutting or grinding surface.

As an advancement over existing or conventional cutting members, cutting member 100 utilizes abrasive elements 130 (comprised of diamond-grit-bearing, sintered compound) integrated within body 110 of cutting member 100. Thus, cutting member 100 eliminates the limiting edge-mounted abrasive element configuration of existing cutting members. The novel configuration of diamond-grit-bearing, sintered abrasive elements integrated within the body of cutting member 100 reduces the fragility and frequent breaking limitations of conventional cutting members.

Moreover, cutting member 100 has demonstrated increased resiliency, increased cutting speed, and extended working lifespan over conventional cutting members. Cutting member 100 has demonstrated the ability to withstand percussion effects prevalent when performing interrupted cutting or coring of sharp-edged, hard rock fracture zones. The relatively soft body 110 of cutting member 100 has a dampening effect on shock waves encountered when drilling in fracture zones. Additionally, it is postulated that the dampening effect of body 110 will allow cutting member 100 to be operated at rotation speeds exceeding 10,000 rpm.

Moreover, cutting member 100 has demonstrated a working life extending greatly beyond the working life of conventional cutting members. Existing cutting members thin and dull quickly, which leads to loss of gauge and end of useful working life. However, the continuous regenerating properties of abrasive elements 130 allow cutting member 100 to maintain gauge for greater overall working lifespan, thus reducing the likelihood of lost time and money which plagues existing cutting members.

As shown in FIG. 1, body 110 is configured as a cylinder to define a coring drill bit. Additionally or alternatively, the body may be configured as a solid drill bit or circular saw blade.

As shown in FIGS. 1-3, body 110 is configured as a 2-inch outside diameter, 1-inch long cylindrical coring drill bit. In further examples, the body may have a different outside diameter, including, but not limited to, outside diameters of 1-10 inches. Additionally, the body may have any outside diameter suitable for a given drilling, coring, cutting, or grinding application.

Additionally or alternatively, the body may have any length coring drill bit that facilitates or allows drilling or coring of solid materials. Suitable lengths, include, but are not limited to, 1-12 inches.

Increasing the length of the coring bit while concurrently increasing the number of abrasive elements integrated in the body has been found to increase cutting or coring speed and efficiency Likewise, increasing the outside diameter and length of the body while concurrently increasing the number of abrasive elements integrated in the body has been found to increase cutting or coring speed and efficiency.

Body 110 variably erodes during use to facilitate or allow natural relief or exposure of embedded abrasive elements 130. Additionally or alternatively, the body may be eroded artificially by filing or grinding material away from the embedded abrasive elements. Relieving or exposing the abrasive elements helps circulate air, water, additives, amended water, or other cutting fluids over the abrasive elements during use. Efficient circulation is important for removing solid material cuttings and dissipating friction heat generated during drilling, coring, cutting or grinding.

In one example, body 110 is comprised of brass, which has been identified as particularly effective as a body material. The physical properties of brass facilitate exposing the embedded abrasive elements as the body erodes differentially during use, thereby facilitating or allowing cutting member 100 to self-sharpen and become more effective with each use.

Additionally or alternatively, the body may be comprised of any relatively soft metallic compound that variably erodes when used, including, but not limited to, stainless steel, copper, bronze, zinc, and alloys. Additionally or alternatively, the body may be comprised of any now known or later developed solid material that facilitates or allows the body to retain the integrated abrasive elements, but concurrently allows the cutting member to self-sharpen or be artificially sharpened. Suitable solid materials include, but are not limited to, wood, metal, plastic, ceramics, and composites.

Also shown in FIG. 1, first surface 112 comprises the outer surface of cutting member 100. First surface 112 is substantially aligned with second surface 114 and extends in a plane transverse to leading surface 116. Abrasive elements 130 are integrated in body 110 transverse to first surface 112. Moreover, abrasive elements 130 extend a uniform distance 140 beyond first surface 112.

Extending the abrasive elements 130 beyond first surface 112 facilitates or allows effectively removing solid material when drilling, coring, cutting, or grinding with cutting member 100. The gullets or reliefs facilitate or allow first surface 112 to remove or channel solid material away from integrated abrasive elements 130 as they drill, core, cut, or grind the solid material. Thus, as an advancement over existing cutting members, cutting member 100 not only drills, cores, cuts, or grinds solid material at the leading surface 116, but also removes material with first surface 112.

As shown in FIGS. 1 and 3, second surface 114 comprises the inner surface of cutting member 100. Second surface 114 is substantially aligned with first surface 112 and extends in a plane transverse to leading surface 116.

Abrasive elements 130 are integrated in body 110 transverse to second surface 114. Moreover, in FIG. 3, abrasive elements 130 extend a uniform distance 142 beyond second surface 114. Thus, improving cutting members known in the art, cutting member 100 not only drills, cores, cuts, or grinds solid material at the leading surface 116, but also removes material with first surface 112 and with second surface 114.

As shown most clearly in FIG. 1, second surface 114 may be configured to expose maximum surface area of abrasive elements 130. Additionally or alternatively, the second surface may be configured to expose less surface area of the abrasive elements. In either case, the second surface variably erodes during use to further expose the integrated abrasive elements.

As shown in FIGS. 1 through 3, leading surface 116 is transverse first surface 112 and second surface 114. Abrasive elements 130 are integrated in body 110 and extend beyond leading surface 116. In one example, leading surface 116 includes gullets or reliefs between abrasive elements 130. The gullets or reliefs facilitate or allow leading surface 116 to remove or channel solid material away from integrated abrasive elements 130 extending beyond leading surface 116.

Also shown in FIGS. 1 through 3, abrasive elements 130 are integrated in body 110. In one example, abrasive elements 130 are cylindrical disks. Additionally or alternatively, the abrasive elements may be any shape that facilitates or allows fixedly embedding or integrating the abrasive elements within the body, including, but not limited to, cylinders, rods, cones, cubes, pyramids, diamonds, and spheres.

In one example, abrasive elements 130 are configured as 7 mm outside diameter, 3.5 mm thick cylindrical disks. Additionally or alternatively, the abrasive elements may be configured in any outside diameter and thickness that facilitates or allows the abrasive elements to extend beyond the body (of the cutting members). The abrasive elements may extend beyond the body either transverse the first surface and the second surface or transverse the leading surface.

Moreover, in the example shown in FIG. 1, abrasive elements 130 are comprised of a diamond-grit-bearing, sintered compound. Additionally, or alternatively, the abrasive elements may be comprised of any now known or later developed material suitable for drilling, coring, cutting, or grinding solid materials, including, but not limited to hardened steel, titanium, and tungsten carbide.

As depicted in FIG. 1, first surface 112 and second surface 114 are attached by attaching surface 118. Attaching surface is distal leading surface 116. Additionally, attaching surface 118 extends between first surface 112 and second surface 114. In the present example, attaching surface 118 is fixedly secured to attaching member 120. Additionally or alternatively, the attaching surface may be removably secured to the attaching member.

In the example shown in FIGS. 1-3, attaching surface 118 is comprised of the same material as body 110, namely brass. Additionally or alternatively, attaching surface may be comprised of a different material than body 110, including, but not limited to, stainless steel, copper, bronze, zinc, and alloys. Additionally or alternatively, attaching surface may be comprised of any now known or later developed material, including, but not limited to, wood, metal, plastic, ceramics, and composites.

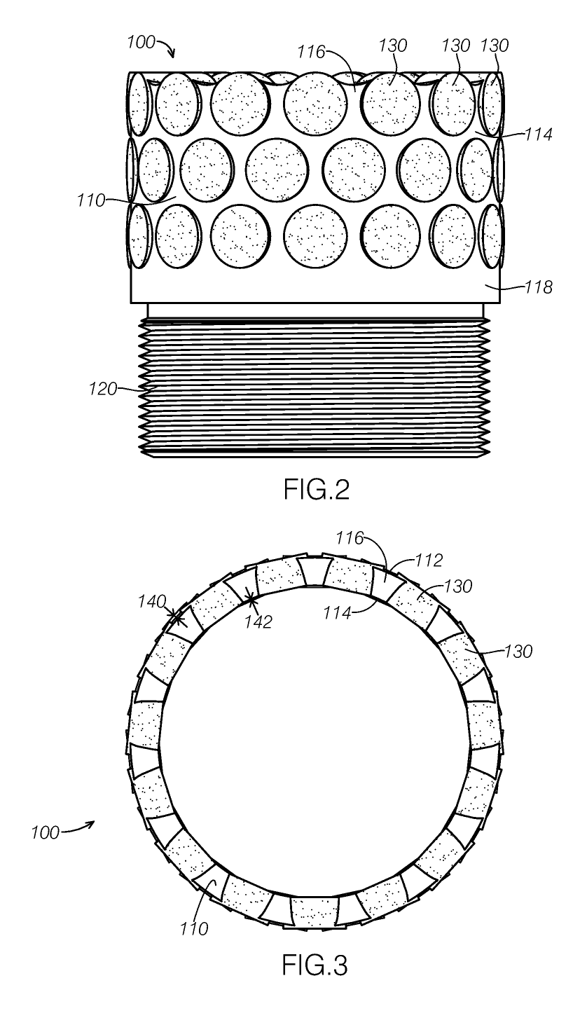

As shown in FIGS. 1 and 2, attaching member 120 is configured to facilitate or allow attaching cutting member 100 to a threaded bore, namely the threaded bore of a coring drill drive shaft. Additionally or alternatively, the attaching members may be configured to facilitate or allow attaching cutting members to drive members by any now known or later developed attaching method, including, but not limited to, slot-pin, slide-lock, and pressure clamp. Additionally or alternatively, the attaching member may permanently or fixedly attach the cutting members to a drill drive shaft.

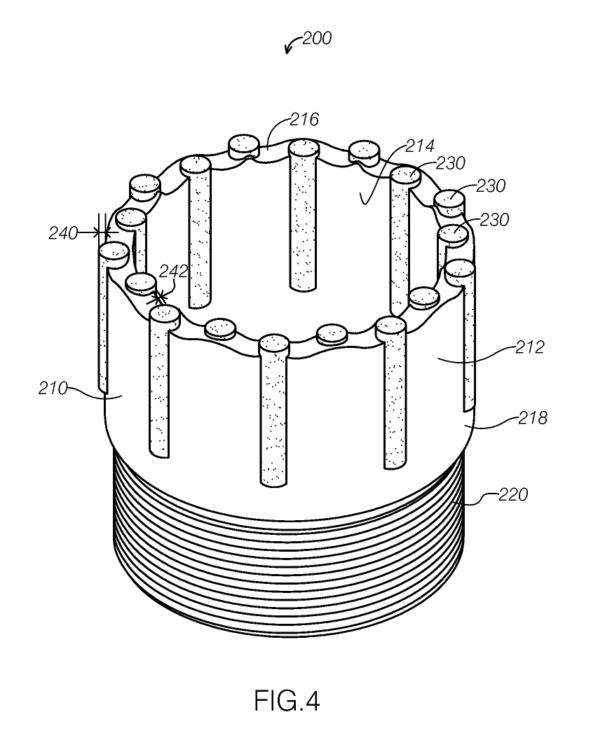

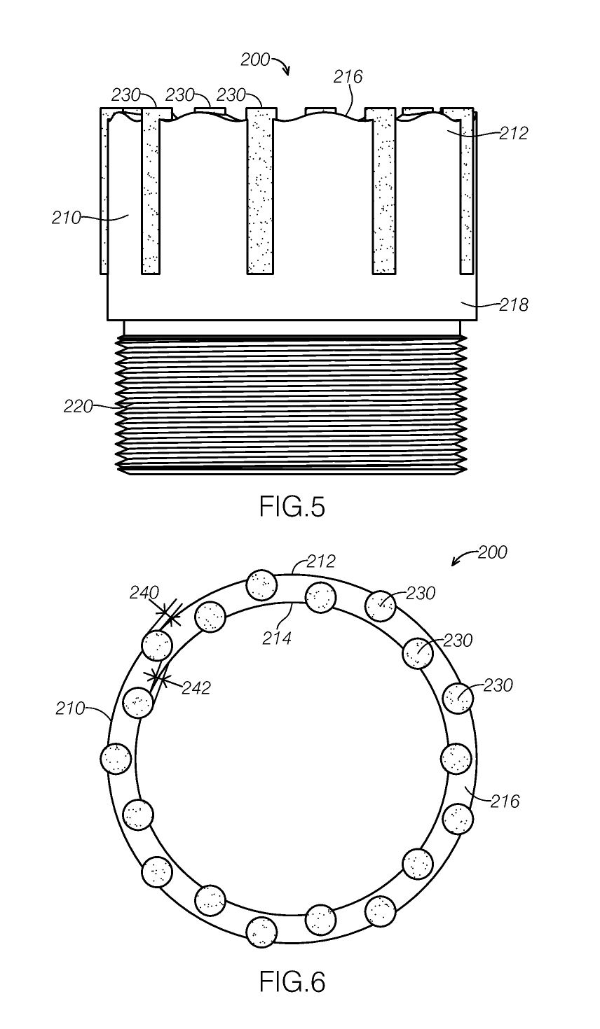

Turning attention to FIGS. 4-6, a second example of a cutting member, cutting member 200, will now be described. Cutting member 200 includes many similar or identical features to cutting member 100. Thus, for the sake of brevity, each feature of cutting member 200 will not be redundantly explained. Rather, key distinctions between cutting member 200 and cutting member 100 will be described in detail and the reader should reference the discussion above for features substantially similar between the two cutting members.

As can be seen in FIG. 4, cutting member 200 includes a cylindrical body 210, a first surface 212, a second surface 214, a leading surface 216, an attaching surface 218, an attaching member 220, and a plurality of abrasive elements 230. Cutting member 200 is also configured to drill or core solid materials; however, integrated abrasive elements 230 are oriented transverse leading surface 216, rather than transverse first surface 212 and second surface 214.

Abrasive elements 230 are integrated in body 210 and extend beyond first surface 212 a uniform distance 240 and extend a uniform distance 242 beyond second surface 214 as well. Abrasive elements 230 extend beyond leading surface 216 to facilitate or allow removing or channeling solid material away from abrasive elements 230 as they drill, core, cut, or grind solid material.

As shown most clearly in FIG. 6, abrasive elements 230 are configured in a staggered or alternating configuration so that, moving circumferentially around body 210, every other abrasive element 230 extends beyond either first surface 212 or second surface 214, but not both.

Additionally or alternatively, the abrasive elements may extend beyond both the first surface and the second surface. The abrasive elements may be configured such that a first set of abrasive elements on the first surface substantially aligns with a second set of abrasive elements on the second surface, the first set of abrasive elements extends beyond the first surface and the leading surface, and the second set of abrasive elements extends beyond the second surface and the leading surface.

As shown in FIG. 4, abrasive elements 230 are configured as cylindrical rods. In one example, abrasive elements 230 are configured as 2 mm outside diameter, 15 mm long cylindrical rods. Additionally or alternatively, the abrasive elements may be configured in any outside diameter and length that facilitates or allows the abrasive elements to extend beyond the body of the cutting members. Additionally or alternatively, the abrasive elements may be configured in any shape that facilitates or allows fixedly embedding or integrating the abrasive elements within the body, including, but not limited to disks, rods, cones, cubes, pyramids, diamonds, and spheres.

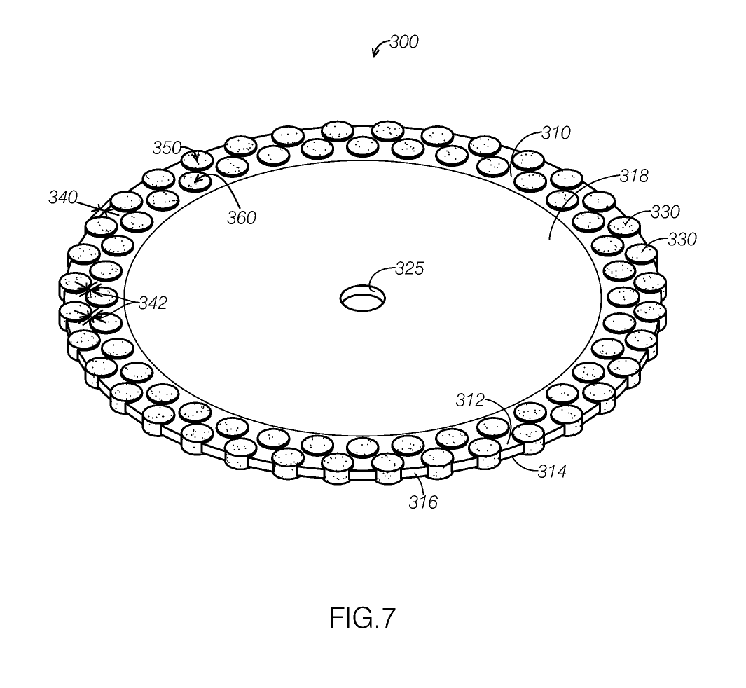

Turning attention to FIGS. 7-10, a third example of a cutting member, cutting member 300, will now be described. Cutting member 300 includes body 310, a first surface 312, a second surface 314, a leading surface 316, an attaching surface 318, an aperture 325, and a plurality of abrasive elements 330.

Cutting member 300 is configured as a circular disk and functions to cut or grind solid materials. Specifically, cutting member 300 is configured as a circular saw blade for cutting solid materials, including, but not limited to, natural rock, concrete and metal. Additionally or alternatively, the cutting member can be used for solid material demolition.

As shown in FIG. 7, abrasive elements 330 are oriented transverse first surface 312 and transverse second surface 314. Abrasive elements 330 extend a uniform distance 340 beyond leading surface 316. As described above, leading surface 316 includes gullets or reliefs between abrasive elements 330. The gullets or reliefs facilitate or allow leading surface 316 to remove or channel solid material away from abrasive elements 330 when cutting solid material with cutting member 300.

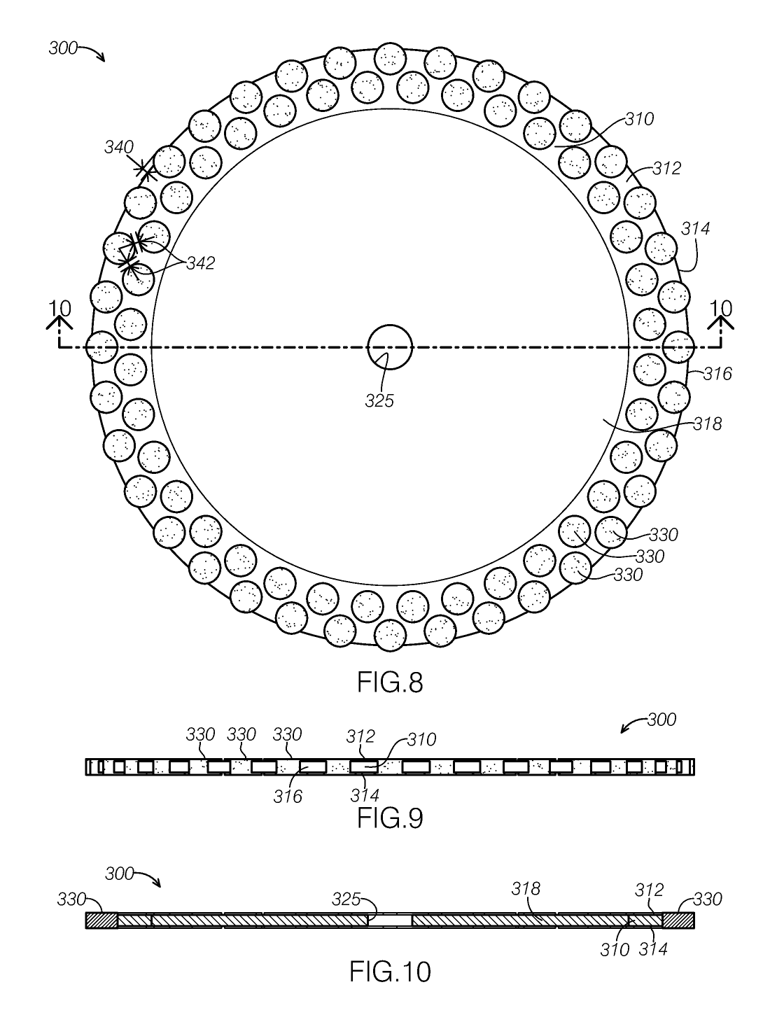

As seen in FIGS. 7 and 8, abrasive elements 330 are integrated in body 310 circumferentially around the outer edge of cutting member 300 and define a primary ring 350 and a secondary ring 360. Abrasive elements 330 in secondary ring 360 are spaced a uniform distance 342 away from abrasive elements 330 in primary ring 350.

Additionally or alternatively, cutting members may have abrasive elements arranged in a primary ring circumferentially around the leading edge of the cutting member with no secondary ring of abrasive elements. Additionally or alternatively, there may be a secondary ring and a tertiary ring of abrasive elements. In such a configuration, the secondary ring of abrasive elements may be spaced uniformly from the primary ring and the tertiary ring, or non-uniformly from the primary ring and the tertiary ring. Additionally or alternatively, all the abrasive elements may be configured in the same configuration or in different configurations. For example, the abrasive elements may all be configured as cylindrical disks, or the abrasive elements may be configured as a combination of abrasive rods and abrasive cones.

As shown in FIGS. 7, 8, and 10, cutting member 300 includes attaching surface 318. Attaching surface 318 is distal leading surface 316. Attaching surface 318 extends between first surface 312 and second surface 314. Moreover, attaching surface defines aperture 325, which is configured to accommodate a rotating drive shaft, specifically the rotating drive shaft of a power saw.

In the example shown in FIG. 7, attaching surface 318 is fixedly attached to body 310. Additionally or alternatively, the attaching surface may be removably attached to the body to facilitate or allow changing the body or the attaching surface if either becomes damaged or destroyed.

In the example shown in FIG. 7, attaching surface 318 is comprised of stainless steel. Additionally or alternatively, the attaching surface may be comprised of brass, copper, bronze, zinc, and alloys. Additionally or alternatively, the attaching surface may be comprised of any now known or later developed solid material that facilitates or allows the attaching surface to retain the body and define an aperture capable of accommodating a rotating drive shaft, including, but not limited to, wood, metal, plastic, ceramics, and composites.

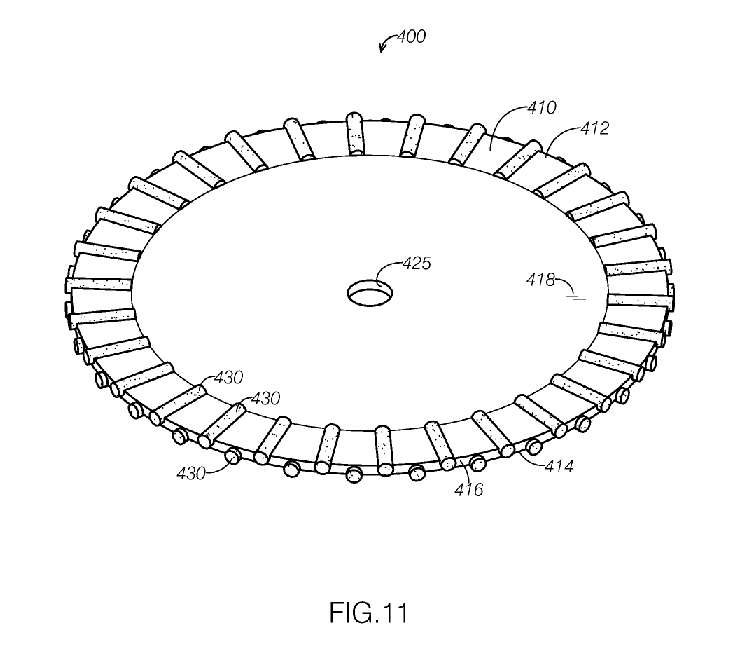

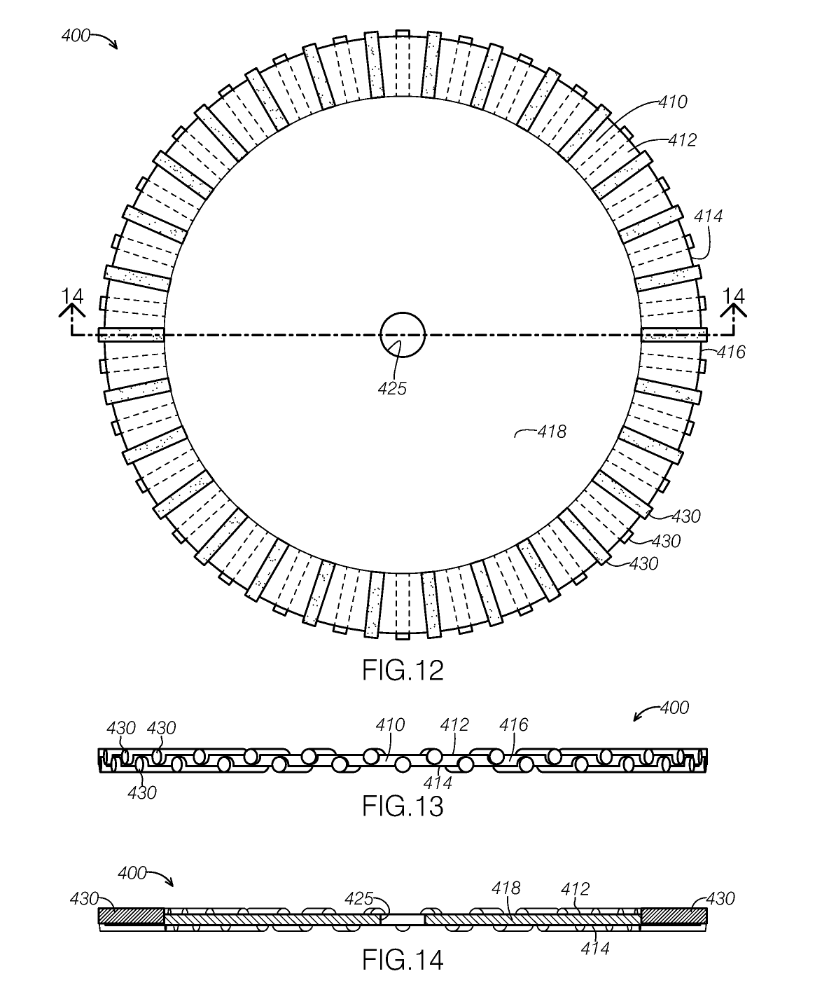

Turning attention to FIGS. 11-14, a fourth example of a cutting member, cutting member 400, will now be described. Cutting member 400 includes a body 410, a first surface 412, a second surface 414, a leading surface 416, an attaching surface 418, an aperture 425, and a plurality of abrasive elements 430.

As shown in FIGS. 11 and 12, abrasive elements 430 are configured transverse leading surface 416 and extend beyond first surface 412 and second surface 414. In the current example, abrasive elements 430 are configured in a staggered or alternating configuration so that moving circumferentially around leading surface 416 every other abrasive element 430 extends beyond either first surface 412 or second surface 414, but not both.

Additionally or alternatively, the abrasive elements may extend beyond both the first surface and the second surface. Additionally or alternatively, the abrasive elements may be configured such that a first set of abrasive elements on the first surface substantially aligns with a second set of abrasive elements on the second surface, the first set of abrasive elements extends beyond the first surface and the leading surface, and the second set of abrasive elements extends beyond the second surface and the leading surface.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein. Claims:

1. A cutting member, comprising:
a body including:
a first surface,
a second surface spaced from the first surface and extending in a plane substantially aligned with the first surface,
a leading surface extending between the first surface and the second surface, the leading surface extending in a plane transverse to the first surface and the second surface, and
an attaching surface distal the leading surface, the attaching surface extending between the first surface and the second surface; and
a plurality of abrasive elements integrated in the body.

2. The cutting member of claim 1, further comprising an attaching member fixedly secured to the attaching surface.

3. The cutting member of claim 2, wherein the attaching member is configured to attach the cutting member to a rotating drive shaft.

4. The cutting member of claim 1, wherein the plurality of abrasive elements extend transverse to the first surface and the second surface.

5. The cutting member of claim 4, wherein the plurality of abrasive elements extend a uniform distance beyond the first surface.

6. The cutting member of claim 5, wherein the plurality of abrasive elements extend a uniform distance beyond the second surface.

7. The cutting member of claim 6, wherein the plurality of abrasive elements are comprised of diamond-grit-bearing, sintered compound.

8. The cutting member of claim 7, wherein the plurality of abrasive elements are configured as cylindrical disks.

9. The cutting member of claim 8, wherein the cutting member defines a coring drill bit.

10. The cutting member of claim 8, wherein the cutting member defines a circular saw blade.

11. A cutting member, comprising:
a cylindrical body including:
a first surface,
a second surface spaced from the first surface and substantially aligned with the first surface,
a leading surface extending between the first surface and the second surface, the leading surface transverse to the first surface and the second surface, and
an attaching surface distal the leading surface, the attaching surface extending between the first surface and the second surface, and
an attaching member attached to the attaching surface; and
a plurality of abrasive elements integrated in the body.

12. The cutting member of claim 11, wherein the attaching member is configured to attach the cutting member to a threaded bore.

13. The cutting member of claim 12, wherein the plurality of abrasive elements are integrated in the body transverse the leading surface.

14. The cutting member of claim 13, wherein the plurality of abrasive elements are configured as cylindrical rods.

15. The cutting member of claim 14, wherein the plurality of abrasive elements are arranged in a staggered pattern and extend a uniform distance beyond the first surface and a uniform distance beyond the second surface.

16. A cutting member, comprising:
a body defining a circular disk including:
a first surface,
a second surface spaced from the first surface and substantially aligned with the first surface,
a leading surface extending between the first surface and the second surface, and
an attaching surface distal the leading surface, the attaching surface extending between the first surface and the second surface; and
a plurality of abrasive elements integrated in the body.

17. The cutting member of claim 16, wherein the attaching surface defines an aperture configured to accommodate a rotating drive shaft.

18. The cutting member of claim 17, wherein the plurality of abrasive elements are integrated in the body transverse the first surface and the second surface.

19. The cutting member of claim 18, wherein the plurality of abrasive elements are circumferentially integrated in the body to define a primary ring of abrasive elements extending a uniform distance beyond the leading surface.

20. The cutting member of claim 19, wherein the plurality of abrasive elements integrated in the body further define a secondary ring of abrasive elements, the abrasive elements in the secondary ring spaced a uniform distance from the abrasive elements in the primary ring.
